(19) United States
(12) Patent Application Publication
(10) Pub. No.: US 2014/0004960 A1
(43) Pub. Date: Jan. 2, 2014

(54) DYNAMIC PLAYER MATCH-MAKING FOR SOCIAL GAMES

(71) Applicant: Zynga Inc., San Francisco, CA (US)

(72) Inventors: Dheeraj Soti, San Jose, CA (US); Daniel McCaffrey, San Bruno, CA (US); Rushan Chen, San Francisco, CA (US); Vishal R. Kapoor, San Francisco, CA (US)

(21) Appl. No.: 13/929,215

(22) Filed: Jun. 27, 2013

Related U.S. Application Data
(60) Provisional application No. 61/665,229, filed on Jun. 27, 2012.

(51) Int. Cl. A63F 13/12

(52) U.S. Cl. CPC A63F 13/12
USPC 463/42

(57) ABSTRACT

Methods, systems, and apparatus for player match-making in a gaming system are described. A search request comprising one or more attributes of one or more players of the online social game may be received. One or more attributes of one or more players of an online social game may be determined. One or more players of the online social game with attributes corresponding to the search request may be identified and a recommendation for at least one matching player may be generated.

### CROSS REFERENCE TO RELATED APPLICATIONS

This non-provisional patent application claims priority to the filing date of U.S. Provisional Patent Application Ser. No. 61/665,229, filed Jun. 27, 2012, and entitled, “DYNAMIC MATCH-MAKING MODEL FOR SOCIAL GAMES,” the entirety of which is incorporated by reference herein.

### TECHNICAL FIELD

The present disclosure generally relates to games and applications and, in example embodiments, to computer-implemented, online social games.

### BACKGROUND

Online social games are becoming widespread. The success of an online social game depends on the number of players and how often these players visit the online social game. As such, the retention of players of online social games is an important factor towards the success of the online social games. The retention of players may be important for the success of the online social games and the number of social connections of a player may be an important factor that may drive retention.

### BRIEF DESCRIPTION OF THE DRAWINGS

The present disclosure is illustrated by way of example, and not by way of limitation, in the figures of the accompanying drawings in which:

FIG. 1 illustrates an example of a system for implementing example disclosed embodiments;

FIG. 2 illustrates a graphical representation of an example social network, in accordance with an example embodiment;

FIG. 3 illustrates an example data flow in a gaming system, in accordance with an example embodiment;

FIG. 4 is a block diagram of the example game networking system and dynamic match-making system, in accordance with an example embodiment;

FIG. 5 is a flowchart for a method for using attribute data to perform player match-making, in accordance with an example embodiment;

FIG. 6 is a block diagram of an example embodiment of a match-making data loader for generating indices for accessing attribute data to perform player match-making and for loading the indices and attributes into a match-making system, in accordance with an example embodiment;

FIG. 7 is a flowchart for a method for generating indices for accessing attribute data to perform player match-making, in accordance with an example embodiment;

FIG. 8 is a block diagram of an example match-making system for providing player match-making for one or more games, in accordance with an example embodiment;

FIG. 9 is a flowchart for a method for performing player match-making, in accordance with an example embodiment;

FIG. 10 illustrates an example network environment for the gaming system of FIG. 3, in accordance with an example embodiment; and

FIG. 11 illustrates an example of a computer system architecture, in accordance with an example embodiment.

### DETAILED DESCRIPTION

In the following detailed description of example embodiments, reference is made to specific examples by way of drawings and illustrations. These examples are described in sufficient detail to enable those skilled in the art to practice these example embodiments, and serve to illustrate how aspects of the disclosure may be applied to various purposes or embodiments. Other embodiments exist and are within the scope of the disclosure, and logical, mechanical, electrical, and other changes may be made without departing from the scope or extent of the present disclosure. Features or limitations of various example embodiments described herein, however essential to the example embodiments in which they are incorporated, do not limit the scope of the disclosed subject matter as a whole. Any reference to the invention, or to the disclosure, its elements, operation, and application do not limit the scope of the disclosure as a whole but serve only to describe these example embodiments. The following detailed description does not, therefore, limit the scope of the disclosure, which is defined only by the appended claims.

### Dynamic Match-Making Model/Framework for Social Games

Generally, methods, systems, and apparatus for performing player match-making in a social gaming environment are described. For social games, it may not always be possible to find suitable matches for a player within their friend's network. While social games may have millions of users, pairing those players at run time based on different attributes can be a challenge. Dynamic match-making frameworks and models may empower game studios to increase social features of their games by building a mechanism within the game which allows players to expand their connections and social interactions beyond their network of friends. The framework allows games to request potential matches based on multiple attributes for a player within the game flow. An example call to the framework could be “give me ‘n’ highly engaged players whose level and country are same as mine.” The framework may have the ability to dynamically discover matches based on 100 or more different attributes. These attributes may be simple demographic or gender-based attributes, or may be related to a complex analytical model. For example, a complex analytical model may pair two users who have similar “likelihood to share” scores. The framework may support relative matching where the conditions may be dynamic, i.e. as attributes, such as skill level, of a player changes within the game, the player may get different matches relative to those attributes. The matched players may request help from each other towards reaching certain goals, may gift items to their matched players (such as mystery gifts, parts, and the like), may visit and send thank-you gifts, and the like.

### Backend—Support Dynamic Match-Making Through a Key-Value Store

Key-value stores may be used by applications for real time services. The key-value stores may support very fast in-memory hash-lookups where, given a key, a value may be looked-up. For example, given a user, the level of the user in a game may be easily looked-up. The reverse may be more difficult; given a level, the lookup of users who are characterized by that level may be more challenging. One reason for the difficulty may be due to a difficulty in reading all keys based on a certain value. To support dynamic match-making in a key-value store (membase) environment, indexes of users may be built in such a way that millisecond latency calls with dynamic conditions may be achieved. The indexes may be sharded into chunks such that calls may access different shards to ensure that the returned set of users may be randomized. This prevents the same users from being repeatedly identified as a matching player.

### Example Online Game Networking System

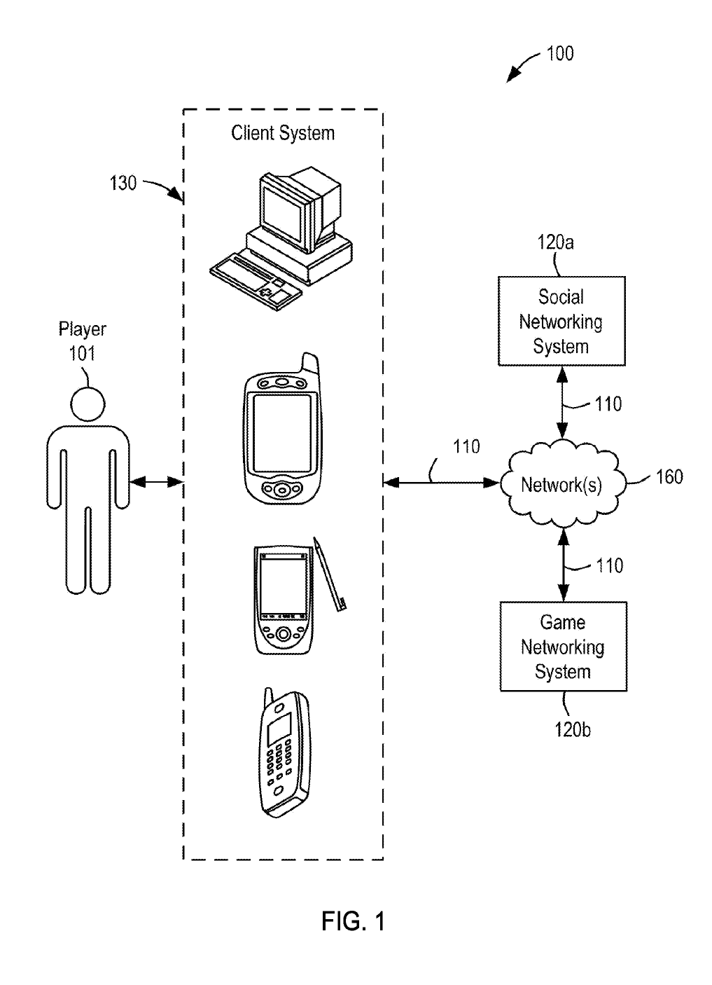

FIG. 1 illustrates an example of a system 100 for implementing example disclosed embodiments. In one example embodiment, the system 100 may comprise a player 101, a social networking system 120a, a game networking system 120b, a client system 130, and a network 160. The components of system 100 may be connected to each other in any suitable configuration, using any suitable type of connection. The components may be connected directly or over a network 160, which may be any suitable network. For example, one or more portions of network 160 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another type of network, or a combination of two or more such networks.

The social networking system 120a may be a network-addressable computing system that can host one or more social graphs. The social networking system 120a may generate, store, receive, and transmit social networking data. The social networking system 120a may be accessed by the other components of the system 100 either directly or via the network 160.

The game networking system 120b may be a network-addressable computing system that may host one or more online games. The game networking system 120b may generate, store, receive, and transmit game-related data, such as, for example, game account data, game input, game state data, game displays, and the like. The game networking system 120b may be accessed by the other components of the system 100 either directly or via the network 160.

The player 101 may use client system 130 to access, send data to, and receive data from the social networking system 120a and the game networking system 120b. The client system 130 may access the social networking system 120a or the game networking system 120b directly, via the network 160, or via a third-party system. As an example and not by way of limitation, the client system 130 may access the game networking system 120b via the social networking system 120a. The client system 130 may be any suitable computing device, such as a personal computer, laptop, cellular phone, smart phone, computing tablet, and the like.

Although FIG. 1 illustrates a particular number of players 101, social networking systems 120a, game networking systems 120b, client systems 130, and networks 160, this disclosure contemplates any suitable number of players 101, social networking systems 120a, game networking systems 120b, client systems 130, and networks 160. As an example and not by way of limitation, the system 100 may include one or more game networking systems 120b and no social networking systems 120a. As another example and not by way of limitation, the system 100 may include a system that comprises both the social networking system 120a and the game networking system 120b. Moreover, although FIG. 1 illustrates a particular arrangement of player 101, social networking system 120a, game networking system 120b, client system 130, and network 160, this disclosure contemplates any suitable arrangement of the player 101, the social networking system 120a, the game networking system 120b, the client system 130, and the network 160.

The components of the system 100 may be connected to each other using any suitable connections 110. For example, the suitable connections 110 may include wireline (such as, for example, Digital Subscriber Line (DSL) or Data Over Cable Service Interface Specification (DOCSIS)), wireless (such as, for example, Wi-Fi or Worldwide Interoperability for Microwave Access (WiMAX)) or optical (such as, for example, Synchronous Optical Network (SONET) or Synchronous Digital Hierarchy (SDH)) connections. In particular embodiments, one or more of the connections 110 may each include an ad hoc network, an intranet, an extranet, a VPN, a LAN, a WLAN, a WAN, a WWAN, a MAN, a portion of the Internet, a portion of the PSTN, a cellular telephone network, or another type of connection, or a combination of two or more such connections. The connections 110 need not necessarily be the same throughout the system 100. One or more first connections 110 may differ in one or more respects from one or more second connections 110. Although FIG. 1 illustrates particular connections between the player 101, the social networking system 120a, the game networking system 120b, the client system 130, and the network 160, this disclosure contemplates any suitable connections between the player 101, the social networking system 120a, the game networking system 120b, the client system 130, and the network 160. As an example and not by way of limitation, in particular embodiments, the client system 130 may have a direct connection to the social networking system 120a or the game networking system 120b, bypassing the network 160.

In an online computer game, a game engine may manage the game state of the game. The game state may comprise a variety of game play parameters. Example game play parameters include player character state, non-player character (NPC) state, in-game object state, game world state (e.g., internal game clocks, game environment, and the like), and the like. Each player 101 may control one or more player characters (PCs). The game engine may control other aspects of the game, such as non-player characters (NPCs), in-game objects, and the like. The game engine may also manage game state, such as player character state for currently active (online) and inactive (offline) players, and the like.

An online game may be hosted by the game networking system 120b, which may be accessed using any suitable connection with a suitable client system 130. A player may have a game account on the game networking system 120b, wherein the game account may contain a variety of information associated with the player (e.g., the player's personal information, financial information, purchase history, player character state, game state, and the like). In some embodiments, a player may play multiple games on the game networking system 120b, which may maintain a single game account for the player with respect to one or more of the games, or multiple individual game accounts for each game with respect to the player. In one example embodiment, the game networking system 120b may assign a unique identifier to each player 101 of an online game hosted on the game networking system 120b. The game networking system 120b may determine that a player 101 is accessing the online game by reading the user's cookies, which may be appended to HTTP requests transmitted by the client system 130 and/or by the player 101 logging onto the online game.

In one example embodiment, the player 101 may access an online game and control the game's progress via the client system 130 (e.g., by inputting commands to the game at the client device). The client system 130 may display the game interface, receive inputs from the player 101, transmit user inputs or other events to the game engine, and receive instructions from the game engine. The game engine may be executed on any suitable system (such as, for example, the client system 130, the social networking system 120a, or the game networking system 120b). As an example and not by way of limitation, the client system 130 may download client components of an online game, which are executed locally, while a remote game server, such as the game networking system 120b, may provide backend support for the client components and may be responsible for maintaining application data of the game, processing the inputs from the player, updating and/or synchronizing the game state based on the game logic and each input from the player, and transmitting instructions to the client system 130. As another example and not by way of limitation, each time the player 101 provides an input to the game through the client system 130 (such as, for example, by typing on the keyboard or clicking the mouse of the client system 130), the client components of the game may transmit the player's input to the game networking system 120b.

### Game Systems, Social Networks, and Social Graphs

In an online multiplayer game, players may control player characters (PCs), while a game engine controls non-player characters (NPCs) and game features and may also manage player character state and game state and may track the state for currently active (i.e., online) players and currently inactive (i.e., offline) players. A player character may have a set of attributes and a set of friends associated with the player character. As used herein, the term “player character state” may refer to any in-game characteristic of a player character, such as location, assets, levels, condition, health, status, inventory, skill set, name, orientation, affiliation, specialty, and the like. Player characters may be displayed as graphical avatars within a user interface of the game. In one example embodiment, no avatar or other graphical representation of the player character may be displayed. The game state may encompass the notion of player character state and may refer to any parameter value that characterizes the state of an in-game element, such as a non-player character, a virtual object (such as a wall or castle), and the like. The game engine may use player character state to determine the outcome of game events, and may also consider set or random variables. Generally, a player character's probability of having a more favorable outcome is greater when the player character has a better state. For example, a healthier player character is less likely to die in a particular encounter relative to a weaker player character or non-player character. In some embodiments, the game engine may assign a unique client identifier to each player.

In one example embodiment, the player 101 may access particular game instances of an online game. A game instance may be a copy of a specific game play area that may be created during runtime. In one example embodiment, a game instance may be a discrete game play area where one or more players 101 may interact in synchronous or asynchronous play. A game instance may be, for example, a level, zone, area, region, location, virtual space, or other suitable play area. A game instance may be populated by one or more in-game objects. Each object may be defined within the game instance by one or more variables, such as, for example, position, height, width, depth, direction, time, duration, speed, color, and the like. A game instance may be exclusive (i.e., accessible by specific players) or non-exclusive (i.e., accessible by any player). In one example embodiment, a game instance may be populated by one or more player characters controlled by one or more players 101 and one or more in-game objects controlled by the game engine. When accessing an online game, the game engine may allow player 101 to select a particular game instance to play from a plurality of game instances. Alternatively, the game engine may automatically select the game instance that the player 101 may access. In one example embodiment, an online game comprises only one game instance that all the players 101 of the online game can access.

In one example embodiment, a specific game instance may be associated with one or more specific players. A game instance may be associated with a specific player when one or more game parameters of the game instance are associated with the specific player. As an example and not by way of limitation, a game instance associated with a first player may be named “First Player's Play Area.” This game instance may be populated with the first player's PC and one or more in-game objects associated with the first player. In one example embodiment, a game instance associated with a specific player may only be accessible by that specific player. As an example and not by way of limitation, a first player may access a first game instance when playing an online game, and this first game instance may be inaccessible to all other players. In other embodiments, a game instance associated with a specific player may be accessible by one or more other players, either synchronously or asynchronously with the specific player's game play. As an example and not by way of limitation, a first player may be associated with a first game instance, but the first game instance may be accessed by all first-degree friends in the first player's social network. In one example embodiment, the game engine may create a specific game instance for a specific player when that player accesses the game. As an example and not by way of limitation, the game engine may create a first game instance when a first player initially accesses an online game, and that same game instance may be loaded each time the first player accesses the game. As another example and not by way of limitation, the game engine may create a new game instance each time a first player accesses an online game, wherein each game instance may be created randomly or selected from a set of predetermined game instances. In one example embodiment, the set of in-game actions available to a specific player may be different in a game instance that is associated with that player compared to a game instance that is not associated with that player. The set of in-game actions available to a specific player in a game instance associated with that player may be a subset, superset, or independent of the set of in-game actions available to that player in a game instance that is not associated with him. As an example and not by way of limitation, a first player may be associated with Blackacre Farm in an online farming game. The first player may be able to plant crops on Blackacre Farm. If the first player accesses a game instance associated with another player, such as Whiteacre Farm, the game engine may not allow the first player to plant crops in that game instance. However, other in-game actions may be available to the first player, such as watering or fertilizing crops on Whiteacre Farm, and the like.

In one example embodiment, a game engine may interface with a social graph. Social graphs may be models of connections between entities (e.g., individuals, users, contacts, friends, players, player characters, non-player characters, businesses, groups, associations, concepts, and the like). These entities may be considered “users” of the social graph; as such, the terms “entity” and “user” may be used interchangeably when referring to social graphs herein. A social graph may have a node for each entity and may have edges to represent relationships between entities. A node in a social graph may represent any entity. In one example embodiment, a unique client identifier may be assigned to each user in the social graph. This disclosure assumes that at least one entity of a social graph may be a player or player character in an online multiplayer game.

The minimum number of edges required to connect a player (or player character) to another user may be considered the degree of separation between them. For example, where the player and the user are directly connected (one edge), they may be deemed to be separated by one degree of separation. The user may be a so-called “first-degree friend” of the player. Where the player and the user are connected through one other user (two edges), they may be deemed to be separated by two degrees of separation. This user would be a so-called “second-degree friend” of the player. Where the player and the user may be connected through N edges (or N−1 other users), they may be deemed to be separated by N degrees of separation. This user would be a so-called “Nth-degree friend.” As used herein, the term “friend” may mean only first-degree friends, unless context suggests otherwise.

Within the social graph, each player (or player character) may have a social network. A player's social network may include all users in the social graph within Nmax degrees of the player, where Nmax may be the maximum degree of separation allowed by the system managing the social graph (such as, for example, the social networking system 120a or the game networking system 120b). In one embodiment, Nmax equals 1, such that the player's social network includes only first-degree friends. In another embodiment, Nmax is unlimited and the player's social network is coextensive with the social graph.

In one example embodiment, the social graph may be managed by the game networking system 120b, which may be managed by the game operator. In other embodiments, the social graph may be part of a social networking system 120a managed by a third-party (e.g., Facebook, Myspace). In one example embodiment, the player 101 may have a social network on both game the networking system 120b and the social networking system 120a, wherein the player 101 may have a social network on the game networking system 120b that is a subset, superset, or independent of the player's social network on the social networking system 120a. In such combined systems, the game network system 120b may maintain social graph information with edge type attributes that indicate whether a given friend is an “in-game friend,” an “out-of-game friend,” or both. The various embodiments disclosed herein may be operable when the social graph is managed by the social networking system 120a, the game networking system 120b, or both.

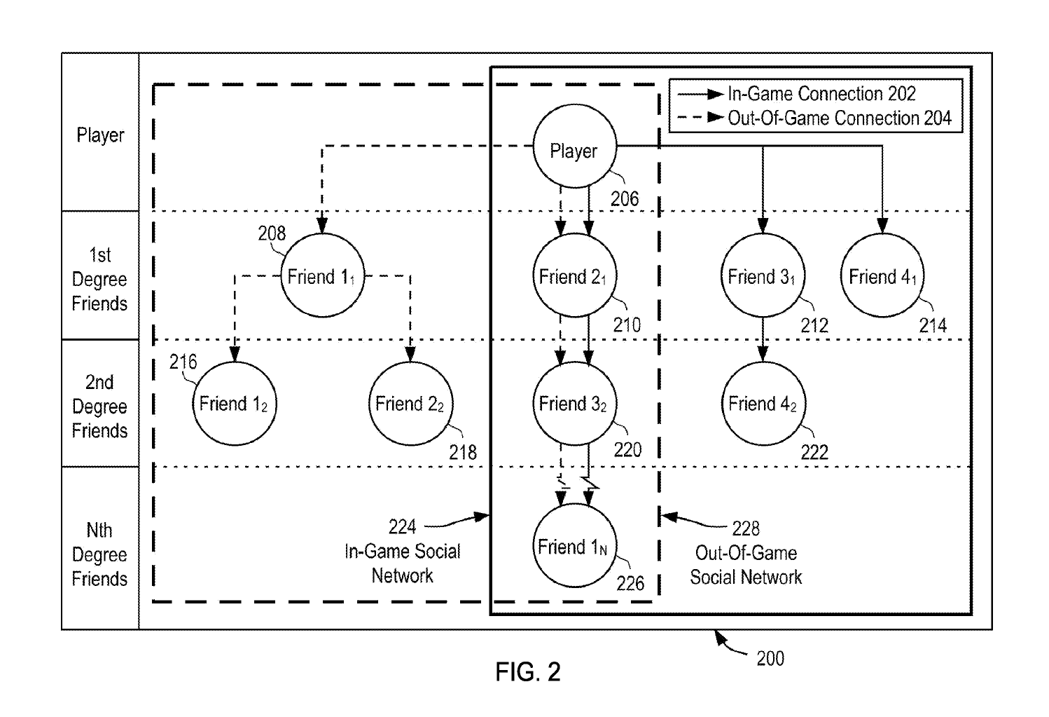

FIG. 2 illustrates a graphical representation of an example social network, in accordance with an example embodiment. As shown, the player 206 may be associated, connected or linked to various other users, or “friends,” within the social network 200. These associations, connections or links can track relationships between users within the social network 200 and are commonly referred to as online “friends” or “friendships” between users. Each friend or friendship in a particular user's social network within a social graph is commonly referred to as a “node.” For purposes of illustration and not by way of limitation, the details of the social network 200 will be described in relation to the player 206. As used herein, the terms “player” and “user” may be used interchangeably and may refer to any user or character in an online multiuser game system or social networking system. As used herein, the term “friend” can mean any node within a player's social network.

As shown in FIG. 2, the player 206 has direct connections with several friends. When the player 206 has a direct connection with another individual that connection may be referred to as a first-degree friend. In the social network 200, the player 206 may have two first-degree friends. That is, the player 206 may be directly connected to Friend 208 and Friend 210. In a social graph, it may be possible for individuals to be connected to other individuals through their first-degree friends (i.e., friends of friends). As described above, each edge required to connect a player to another user may be considered the degree of separation. For example, FIG. 2 shows that the player 206 has three second-degree friends to which he is connected via his connection to his first-degree friends. Second-degree friend 216 and friend 218 are connected to the player 206 via his first-degree friend 208. The limit on the depth of friend connections, or the number of degrees of separation for associations, that the player 206 may be allowed is typically dictated by the restrictions and policies implemented by the social networking system 120a.

In various embodiments, the player 206 may have Nth-degree friends connected to him through a chain of intermediary degree friends as indicated in FIG. 2. For example, the Nth-degree friend 1N 226 is connected to the player 206 via second-degree friend 220 and one or more other higher-degree friends. Various embodiments may take advantage of and utilize the distinction between the various degrees of friendship relative to the player 206.

In one example embodiment, a player (or player character) may have a social graph within an online multiplayer game that may be maintained by the game engine and another social graph maintained by a separate social networking system. FIG. 2 depicts an example of in-game social network 224 and out-of-game social network 228. In this example, the player 206 has out-of-game connections 204 to a plurality of friends, forming out-of-game social network 228. Here, friend 208 and friend 210 may be first-degree friends with the player 206 in his out-of-game social network 228. The player 206 also may have in-game connections 202 to a plurality of players, forming in-game social network 224. Here, friend 212 and friend 214 may be first-degree friends with the player 206 in his in-game social network 224. Friend 222 may be a second-degree friend with the player 206 in his in-game social network 224. In one example embodiment, it may be possible for a friend to be in both the out-of-game social network 228 and the in-game social network 224. Here, the friend 210 may have both an out-of-game connection 204 and an in-game connection 202 with the player 206, such that the friend 210 may be in both the player 206's in-game social network 224 and the player 206's out-of-game social network 228.

As with other social networks, the player 206 may have second-degree and higher-degree friends in both his in-game and out of game social networks. In some embodiments, it may be possible for the player 206 to have a friend connected to him both in his in-game and out-of-game social networks, wherein the friend may be at different degrees of separation in each network. For example, if the friend 218 had a direct in-game connection with the player 206, the friend 218 would be a second-degree friend in the player 206's out-of-game social network, but a first-degree friend in the player 206's in-game social network. In one example embodiment, a game engine may access the in-game social network 224, the out-of-game social network 228, or both.

In one example embodiment, the connections in a player's in-game social network may be formed both explicitly (e.g., users must “friend” each other) and implicitly (e.g., system observes user behaviors and “friends” users to each other). Unless otherwise indicated, reference to a friend connection between two or more players may be interpreted to cover both explicit and implicit connections, using one or more social graphs and other factors to infer friend connections. The friend connections may be unidirectional or bidirectional. It is also not a limitation of this description that two players who are deemed “friends” for the purposes of this disclosure are not friends in real life (i.e., in disintermediated interactions or the like), but that could be the case.

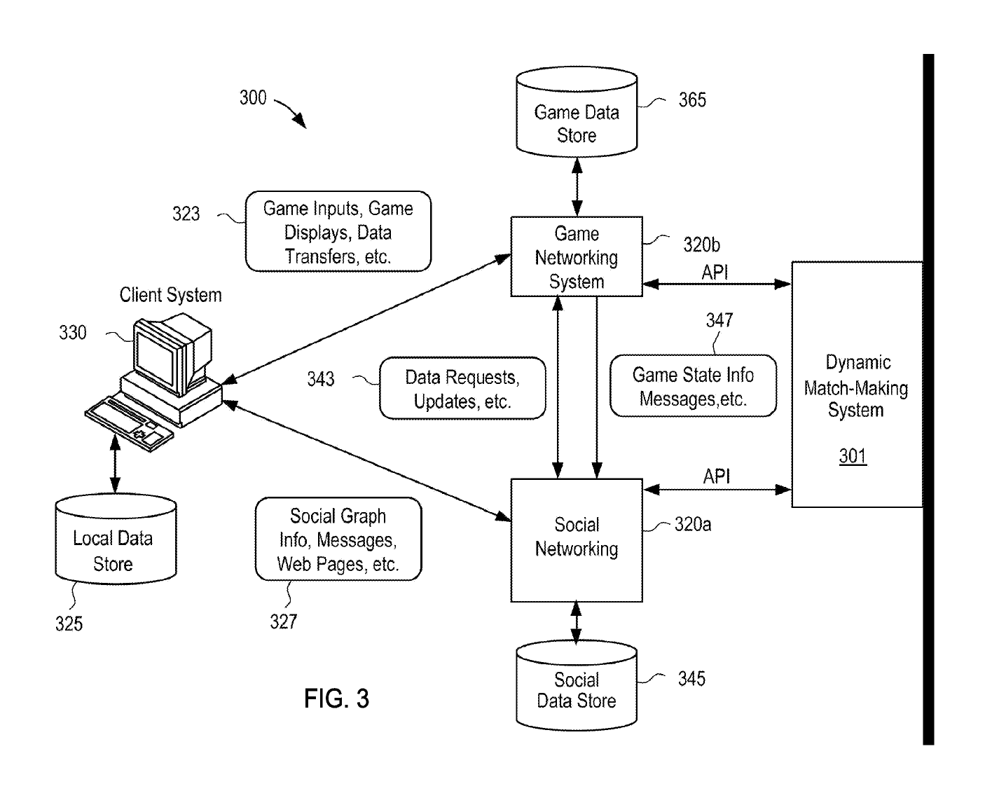

FIG. 3 illustrates an example data flow 300 in a gaming system, in accordance with an example embodiment. In one example embodiment, the system may include a client system 330, a social networking system 320a, and a game networking system 320b. The components of the system may be connected to each other in any suitable configuration, using any suitable type of connection. The components may be connected directly or over any suitable network. The client system 330, the social networking system 320a, and the game networking system 320b may each have one or more corresponding data stores such as local data store 325, social data store 345, and game data store 365, respectively. The social networking system 320a and the game networking system 320b may also have one or more servers that can communicate with the client system 330 over an appropriate network. The social networking system 320a and the game networking system 320b may have, for example, one or more internet servers for communicating with the client system 330 via the Internet. Similarly, the social networking system 320a and the game networking system 320b may have one or more mobile servers for communicating with the client system 330 via a mobile network (e.g., GSM, PCS, Wi-Fi, WPAN, and the like). In some embodiments, one server may be able to communicate with the client system 330 over both the Internet and a mobile network. In one example embodiment, separate servers can be used.

The client system 330 may receive and transmit data 323 to and from the game networking system 320b. This data may include, for example, webpages, messages, game inputs, game displays, HTTP packets, data requests, transaction information, updates, and other suitable data. The game networking system 320b may communicate data 347 (e.g., game state information, game system account information, page information, messages, data requests, updates, and the like) with other networking systems, such as the social networking system 320a (e.g., Facebook, Myspace, and the like). The client system 330 may also receive and transmit data 327 to and from the social networking system 320a. This data may include, for example, webpages, messages, social graph information, social network displays, HTTP packets, data requests, transaction information, updates, and other suitable data.

Communication between the client system 330, the social networking system 320a, and the game networking system 320b may occur over any appropriate electronic communication medium or network using any suitable communications protocols. For example, the client system 330, as well as various servers of the systems described herein, may include Transport Control Protocol/Internet Protocol (TCP/IP) networking stacks to provide for datagram and transport functions. Of course, any other suitable network and transport layer protocols may be utilized.

In addition, hosts or end-systems described herein may use a variety of higher layer communications protocols, including client-server (or request-response) protocols (such as HTTP), other communications protocols (such as HTTP-S, FTP, SNMP, TELNET), and a number of other protocols. In addition, a server in one interaction context may be a client in another interaction context. In one example embodiment, the information transmitted between hosts may be formatted as HyperText Markup Language (HTML) documents. Other structured document languages or formats may be used, such as XML and the like. Executable code objects, such as JavaScript and ActionScript, may also be embedded in the structured documents.

In some client-server protocols, such as the use of HTML over HTTP, a server may generally transmit a response to a request from a client. The response may comprise one or more data objects. For example, the response may comprise a first data object, followed by subsequently transmitted data objects. In one example embodiment, a client request may cause a server to respond with a first data object, such as an HTML page, which itself refers to other data objects. A client application, such as a browser, may request these additional data objects as it parses or otherwise processes the first data object.

In one example embodiment, an instance of an online game may be stored as a set of game state parameters that characterize the state of various in-game objects, such as, for example, player character state parameters, non-player character parameters, virtual item parameters, and the like. In one example embodiment, game state may be maintained in a database as a serialized, unstructured string of text data as a so-called Binary Large Object (BLOB). When a player accesses an online game on the game networking system 320b, the BLOB containing the game state for the instance corresponding to the player may be transmitted to the client system 330 for use by a client-side executed object to process. In one example embodiment, the client-side executable may be a FLASH-based game, which may de-serialize the game state data in the BLOB. As a player plays the game, the game logic implemented at the client system 330 may maintain and modify the various game state parameters locally. The client-side game logic may also batch game events, such as mouse clicks, and may transmit these events to the game networking system 320b. The game networking system 320b may itself operate by retrieving a copy of the BLOB from a database or an intermediate memory cache (memcache) layer. The game networking system 320b may also de-serialize the BLOB to resolve the game state parameters and may execute its own game logic based on the events in the batch file of events transmitted by the client to synchronize the game state on the server side. The game networking system 320b may then re-serialize the game state, now modified, into a BLOB and pass this to a memory cache layer for lazy updates to a persistent database.

With a client-server environment in which the online games may run, one server system, such as the game networking system 320b, may support multiple client systems 330. At any given time, there may be multiple players at multiple client systems 330 playing the same online game. In practice, the number of players playing the same game at the same time may be very large. As the game progresses with each player, multiple players may provide different inputs to the online game at their respective client systems 330, and multiple client systems 330 may transmit multiple player inputs and/or game events to the game networking system 320b for further processing. In addition, multiple client systems 330 may transmit other types of application data to the game networking system 320b.

In one example embodiment, a computer-implemented game may be a text-based or turn-based game implemented as a series of web pages that may be generated after a player selects one or more actions to perform. The web pages may be displayed in a browser client executed on the client system 330. As an example and not by way of limitation, a client application downloaded to the client system 330 may operate to serve a set of web pages to a player. As another example and not by way of limitation, a computer-implemented game may be an animated or rendered game executable as a stand-alone application or within the context of a webpage or other structured document. In one example embodiment, the computer-implemented game may be implemented using Adobe Flash-based technologies. As an example and not by way of limitation, a game may be fully or partially implemented as a SWF object that may be embedded in a web page and executable by a Flash media player plug-in. In one example embodiment, one or more described webpages may be associated with or accessed by the social networking system 320a. This disclosure contemplates using any suitable application for the retrieval and rendering of structured documents hosted by any suitable network-addressable resource or website.

Application event data of a game may be any data relevant to the game (e.g., player inputs). In one example embodiment, each application datum may have a name and a value, and the value of the application datum may change (i.e., be updated) at any time. When an update to an application datum occurs at the client system 330, either caused by an action of a game player or by the game logic itself, the client system 330 may need to inform the game networking system 320b of the update. For example, if the game is a farming game with a harvest mechanic (such as Zynga FarmVille), an event may correspond to a player clicking on a parcel of land to harvest a crop. In such an instance, the application event data may identify an event or action (e.g., harvest) and an object in the game to which the event or action may apply. For illustration purposes and not by way of limitation, the system 300 is discussed in reference to updating a multi-player online game hosted on a network-addressable system (such as, for example, the social networking system 320a or the game networking system 320b), where an instance of the online game is executed remotely on the client system 330, which then transmits application event data to the hosting system such that the remote game server synchronizes game state associated with the instance executed by the client system 330.

In one example embodiment, one or more objects of a game may be represented as an Adobe Flash object. Flash may manipulate vector and raster graphics and support bidirectional streaming of audio and video. “Flash” may mean the authoring environment, the player, or the application files. In one example embodiment, the client system 330 may include a Flash client. The Flash client may be configured to receive and run Flash application or game object code from any suitable networking system (such as, for example, the social networking system 320a or the game networking system 320b). In one example embodiment, the Flash client may be run in a browser client executed on the client system 330. A player may interact with Flash objects using the client system 330 and the Flash client. The Flash objects may represent a variety of in-game objects. Thus, the player may perform various in-game actions on various in-game objects by making various changes and updates to the associated Flash objects. In one example embodiment, in-game actions may be initiated by clicking or similarly interacting with a Flash object that represents a particular in-game object. For example, a player can interact with a Flash object to use, move, rotate, delete, attack, shoot, or harvest an in-game object. This disclosure contemplates performing any suitable in-game action by interacting with any suitable Flash object. In one example embodiment, when the player makes a change to a Flash object representing an in-game object, the client-executed game logic may update one or more game state parameters associated with the in-game object. To ensure synchronization between the Flash object shown to the player at the client system 330, the Flash client may send the events that caused the game state changes to the in-game object to the game networking system 320b. However, to expedite the processing and hence the speed of the overall gaming experience, the Flash client may collect a batch of some number of events or updates into a batch file. The number of events or updates may be determined by the Flash client dynamically or determined by the game networking system 320b based on server loads or other factors. For example, the client system 330 may send a batch file to the game networking system 320b whenever several updates have been collected or after a threshold period of time, such as every minute.

As used herein, the term “application event data” may refer to any data relevant to a computer-implemented game application that may affect one or more game state parameters, including, for example and without limitation, changes to player data or metadata, changes to player social connections or contacts, player inputs to the game, events generated by the game logic, and the like. In one example embodiment, each application datum may have a name and a value. The value of an application datum may change at any time in response to the game play of a player or in response to the game engine (e.g., based on the game logic). In one example embodiment, an application data update occurs when the value of a specific application datum is changed. In one example embodiment, each application event datum may include an action or event name and a value (such as an object identifier). Thus, each application datum may be represented as a name-value pair in the batch file. The batch file may include a collection of name-value pairs representing the application data that have been updated at the client system 330. In one example embodiment, the batch file may be a text file and the name-value pairs may be in string format.

In one example embodiment, when a player plays an online game on the client system 330, the game networking system 320b may serialize all the game-related data, including, for example and without limitation, game states, game events, user inputs, for this particular user and this particular game into a BLOB, and stores the BLOB in a database. The BLOB may be associated with an identifier that indicates that the BLOB contains the serialized game-related data for a particular player and a particular online game. In one example embodiment, while a player is not playing the online game, the corresponding BLOB may be stored in the database. This may enable a player to stop playing the game at any time without losing the current state of the game the player is in. When a player resumes playing the game next time, the game networking system 320b may retrieve the corresponding BLOB from the database to determine the most recent values of the game-related data. In one example embodiment, while a player is playing the online game, the game networking system 320b may also load the corresponding BLOB into a memory cache so that the game system may have faster access to the BLOB and the game-related data contained therein.

A friend recommendation system 301 may communicate with the social networking system 320a and the game networking system 320b. An API may be provided to interface both the social networking system 320a and the game networking system 320b with the friend recommendation system 301. The friend recommendation system 301 may be configured to analyze data including, for example, a frequency of reciprocated users' communications and interactions in the social networking system 320a and the game networking system 320b in order to determine an ASN of a player. In one example embodiment, the friend recommendation system 301 may analyze the communication of players from the game networking system 320b and/or the communication of friends from the social networking system 320a.

Based on the analysis of the data, the friend recommendation system 301 may be able to generate a recommendation of one or more friends or users to socially engage with the player in an online game based on the social network of friends of the player outside the ASN of the player. In one embodiment, the friend recommendation system 301 identifies one or more friends of the player to whom the player may send a message, a virtual gift, a request, and the like. For example, the player may request one or more suggested friends join in on an online mission in the online game. In another example, the player may send virtual gifts to one or more suggested friends in an online game.

A game event may be an outcome of an engagement, a provision of access, rights and/or benefits, or the obtaining of some assets (e.g., health, money, strength, inventory, land, and the like). A game engine may determine the outcome of a game event according to a variety of factors, such as the game rules, a player character's in-game actions, player character state, game state, interactions of other player characters, random calculations, and the like. Engagements may include simple tasks (e.g., plant a crop, clean a stove, and the like), complex tasks (e.g., build a farm or business, run a café, and the like), and other events.

An online game may be hosted by the game networking system 320b, which may be accessed over any suitable network with an appropriate client system 330. A player may have a game system account on a game system of the game networking system 320b, wherein the game system account may contain a variety of information about the player (e.g., the player's personal information, player character state, game state, and the like). In one example embodiment, an online game may be embedded into a third-party website. The game may be hosted by the networking system of the third-party website, or may be hosted on the game system 321 and merely accessed via the third-party website. The embedded online game may be hosted solely on a server of the game system 321 or using a third-party vendor server. In addition, any combination of the functions of the present disclosure may be hosted on or provided from any number of distributed network resources. For example, one or more executable code objects that implement all or a portion of the game may be downloaded to a client system for execution.

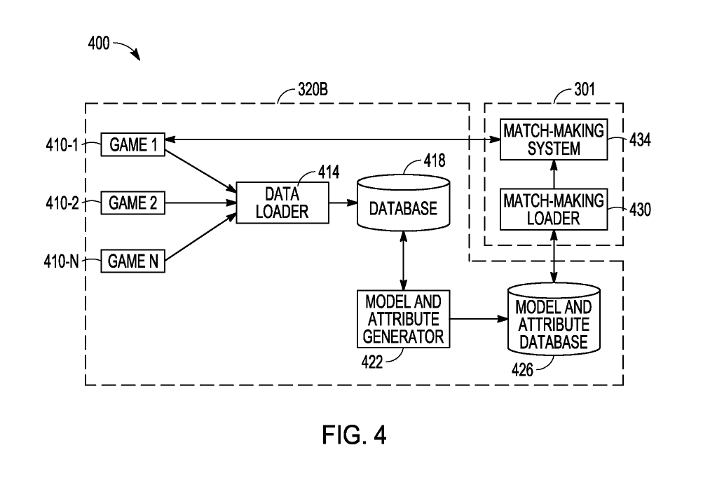

FIG. 4 is a block diagram of an example game networking system 320b and an example dynamic match-making system 301, in accordance with an example embodiment. In one example embodiment, the game networking system 320b may use player attribute data to perform player match-making and may comprise one or more games 410-1, 410-2 and 410-N (known as games 410 hereinafter), a data loader 414, a database 418, a model and attribute generator 422, and a model and attribute database 426. As used herein, a player attribute may comprise an attribute type and attribute value. For example, an attribute type may be age and an attribute value may be 23, and an attribute type may be player language and an attribute value may be English. In another example, a player attribute may be, for example, “experienced.”

In one example embodiment, the dynamic match-making system 301 may comprise a match-making loader 430 and a match-making system 434.

As described more fully above, the game networking system 320b may be a network-addressable computing system that can host one or more online games 410. The game networking system 320b may generate, store, receive, and transmit game-related data, such as, for example, game account data, game input, game state data, game displays, and the like. The game networking system 320b may be accessed by the other components of system 300 either directly or via a network. For example, the client system 330 may access the game networking system 320b directly, via a network, or via a third-party system. The games 410 of the game networking system 320b may log user data for use in, for example, generating and analyzing player and game models, attributes, and statistics.

The data loader 414 may obtain user data logged by the games 410 and may store the logged data into the database 418.

The model and attribute generator 422 may aggregate the logged data in the database 418 and may generate one or more models and one or more player attributes based on the logged data. In one example embodiment, the model and attribute generator 422 may periodically aggregate the logged data and generate the one or more models and the one or more attributes. In one example embodiment, the model and attribute generator 422 may store one or more of the models and/or one or more of the attributes in the model and attribute database 426. Example models may include a predicted player score model, a predicted churn score model, a predicted installer score model, and the like. The attributes for a player may be generated from the models, such as a “likely-to-share-score”, and/or by performing different aggregations on, for example, logged data and/or historical data to derive attributes like “msg-sent-last-n-days” or “payment-amount-last-n-days”, “first-play-date”, “last_play_date”, and the like.

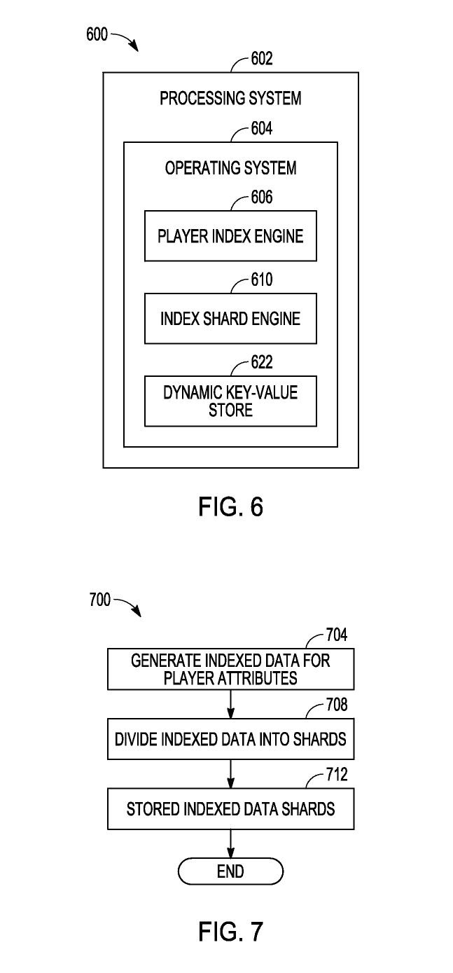

The match-making loader 430 may load one or more attributes associated with the players and, optionally, one or more models from the model and attribute database 426 into the match-making system 434, as described more fully below in conjunction with FIGS. 6 and 7. In one example embodiment, the match-making loader 430 may periodically load the attributes into the match-making system 434.

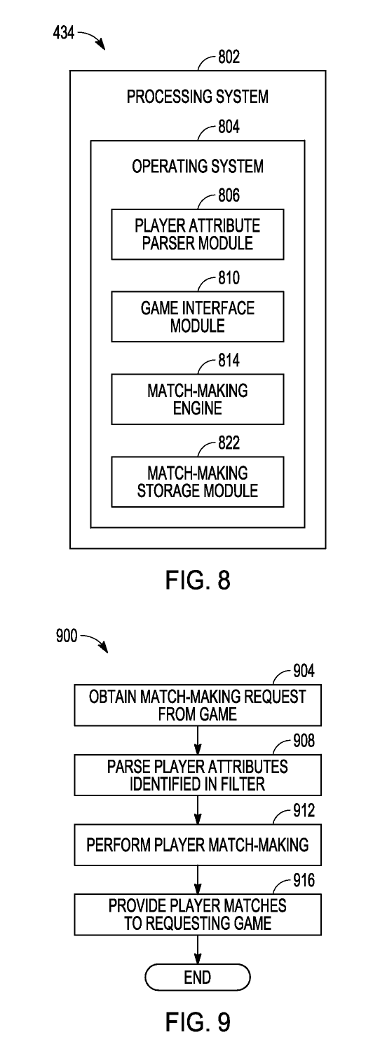

The one or more games 410 of the game networking system 120b may request the match-making system 434 to locate and/or identify one or more matching players for a particular player or group of players. Based on the attributes and, optionally, the models, one or more matching players may be determined and their identities provided to the requesting game(s), as described more fully below in conjunction with FIGS. 8 and 9.

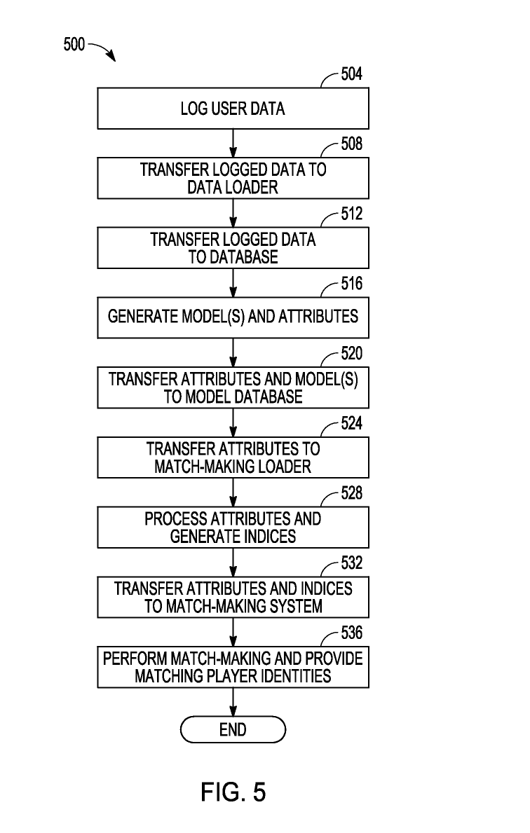

FIG. 5 is a flowchart for a method 500 for using attribute data to perform player match-making, in accordance with an example embodiment. In one example embodiment, one or more of the operations of the match-making method 500 may be performed by the game networking system 320b.

User data may be logged by one or more games 410 of the game networking system 320b (operation 504). For example, the location of a player, playing speed of a player, language of a player, and the like may be logged.

The logged data may be transferred to the data loader 414 (operation 508) and the data loader 414 may store the logged data in the database 418 (operation 512).

The model and attribute generator 422 may aggregate the logged data in database 418 and generate one or more models and one or more attributes based on the logged data in a known manner (operation 516). In one example embodiment, the model and attribute generator 422 periodically aggregates the logged data and generates the one or more models and one or more attributes. For example, the model and attribute generator 422 may aggregate the logged data and generate the one or more models and one or more attributes once a day. In one example embodiment, the one or more models and one or more attributes may be stored in the model and attribute database 426. Example models may include a predicted player score model, a predicted churn score model, a predicted installer score model, and the like.

The model and attribute generator 422 may transfer the generated models and attributes to the model and attribute database 426 (operation 520).

The match-making loader 430 may obtain the attributes (operation 524) and may process the attributes to generate additional attributes and indices that enable the efficient access of the attributes (operation 528), as described more fully below in conjunction with FIGS. 6 and 7. The match-making loader 430 may load the indices and attributes into the match-making system 434 (operation 532). In one example embodiment, the match-making loader 430 periodically loads the indices and attributes into the match-making system 434. For example, the match-making loader 430 may load the indices and attributes into the match-making system 434 once a day.

The one or more games 410 of the game networking system 320b may request the match-making system 434 to locate and/or identify one or more matching players for a particular player or group of players. Based on the indices and attributes stored in the match-making system 434, one or more matching players may be determined and their identities provided to the requesting game(s) (operation 536).

FIG. 6 is a block diagram of an example embodiment of the match-making data loader 430 for generating indices for accessing attribute data to perform player match-making and for loading the indices and attributes into a match-making system 434, in accordance with an example embodiment. In one example embodiment, the match-making data loader 430 may comprise a player index engine 606, an index shard engine 610, and a dynamic key-value store module 622.

The player index engine 606 may generate indices for accessing attribute data to perform player match-making, as described more fully below in conjunction with operation 704 of FIG. 7.

The index shard engine 610 may divide the indices into shards that may be used to efficiently access player attributes, as described more fully below in conjunction with operation 708 of FIG. 7.

The dynamic key-value store module 622 may provide high-bandwidth access for generating and accessing the attributes and indexed data shards. The data may comprise a string that represents the key and the data that represents the value of the key-value pair. The data that represents the value of the key-value pair may be a string, an integer, an array, an object, and the like.

FIG. 7 is a flowchart for a method 700 for generating indices for accessing attribute data to perform player match-making, in accordance with an example embodiment. In one example embodiment, one or more of the operations of the match-making method 700 may be performed by the match-making data loader 430. The number of players and attributes maintained in the game networking system 320b may be very large. For example, a million players may be registered in a gaming environment and each player may be associated with 150 or more attributes. In one example embodiment, one or more indices may be generated to facilitate the accessing of attribute data, for example, for accessing the attribute data of the players (operation 704). Other attributes may also be aggregated and/or generated from one or more alternate data sources. For example, an attribute may be generated from attributes received from the model and attribute database 426 and/or from historical data. As described above, the attributes for a player may be generated from the models, such as a “likely-to-share-score”, and/or by performing different aggregations on, for example, logged data and/or historical data to derive additional attributes.

In one example embodiment, the indices may be divided into shards to facilitate quick access of the attribute(s) associated with each player (operation 708). The indices and/or indexed data shards may be stored in the match-making system 434 to provide for efficient access to the player attributes (operation 712).

FIG. 8 is a block diagram 800 of an example match-making system 434 for providing player match-making for one or more games 410, in accordance with an example embodiment. In one example embodiment, the match-making system 434 may comprise a player attribute parser module 806, a game interface module 810, a match-making engine 814, and a match-making storage module 822.

The player attribute parser module 806 may parse and convert attributes identified in a filter provided by a game 410 to a format compatible with the match-making engine 814.

The game interface module 810 may obtain a player match-making request from the game 410 and may provide an identity of each of one or more matching players to the game 410.

The match-making engine 814 may identify one or more players that match attributes identified by a filter submitted by, for example, the game 410. Based on the attributes identified in the filter, the one or more matching players may be determined and an identity of each of the one or more matching players may be provided to the requesting game(s).

The match-making storage module 822 may store indices for accessing an attribute(s) for each of a plurality of players registered in the game networking system 320b. In one example embodiment, the match-making storage module 822 may store data in a key-value format to facilitate high-bandwidth access to the stored data.

FIG. 9 is a flowchart for a method 900 for performing player match-making, in accordance with an example embodiment. In one example embodiment, one or more of the operations of the match-making method 900 may be performed by the match-making system 434.

In one example embodiment, a filter defining one or more attributes to be used in player match-making may be received from each of one or more games 410 (operation 904). For example, a game 410 may submit a filter corresponding to a player for whom a player match is requested. Each filter may specify one or more attributes to be considered in performing the player matching and may specify a value and/or value range for each of one or more of the specified attributes.

In one example embodiment, player attributes identified in the filter obtained from the game 410 may be parsed (operation 908). The attributes identified in the filter provided by a game 410 may be converted to a format compatible with the match-making engine 814.

One or more players whose attribute(s) match those of the submitted filter may be identified (operation 912). In one example embodiment, all attributes identified in the filter must match a player's corresponding attributes in order for the player to be identified as a match. In one example embodiment, all attributes identified in the filter must substantially match a player's corresponding attributes in order for the player to be identified as a match. In one example embodiment, the closeness of the attributes identified in the filter to a player's corresponding attributes may be used to generate a score for identifying matching players. In one example embodiment, if the score for a player exceeds a predefined threshold, the player may be identified as a matching player. In one example embodiment, the contribution of each attribute type to the score may be weighted differently. For example, player language may be weighted more than player country.

The one or more attributes utilized in the match-making may be obtained from the match-making storage module 822. Other attributes may be aggregated and/or generated from one or more data sources. For example, additional attributes may be generated from attributes residing in the match-making storage module 822 and/or from historical data.

A location and/or identification of the matching player(s) may be provided to the requesting game (operation 916).

For example, a player of an online game 410 may request a search for a matching player to collaborate with on attaining a goal in the game. The player may identify desired attributes of the matching player. For example, the player may specify an age in the range of 20 to 30 years, may specify a player who speaks English, and may specify a player who is “experienced.” The game 410 may optionally augment and/or modify the player specified attributes. For example, the game 410 may replace the “experienced” attribute with a particular player level, and may add an attribute specifying that the matching player's location be the United States or Canada. The search request may be submitted to the match-making system 434.

The player attribute(s) identified in the filter obtained from the game 410 may be parsed (operation 908). If the game 410 recognizes ten player levels and the match-making engine 814 recognizes 7 player levels, the level provided by the game 410 may be normalized to the level range utilized by the match-making engine 814.

At least one player whose attribute(s) match those of the submitted filter may be identified (operation 912). For example, a matching score based on the target attributes (age, language, level, and/or location) may be determined for a plurality of players and the player(s) with the highest score(s) may be identified as matching players. The location and identification of the matching player(s) may be provided to the requesting game (operation 916).

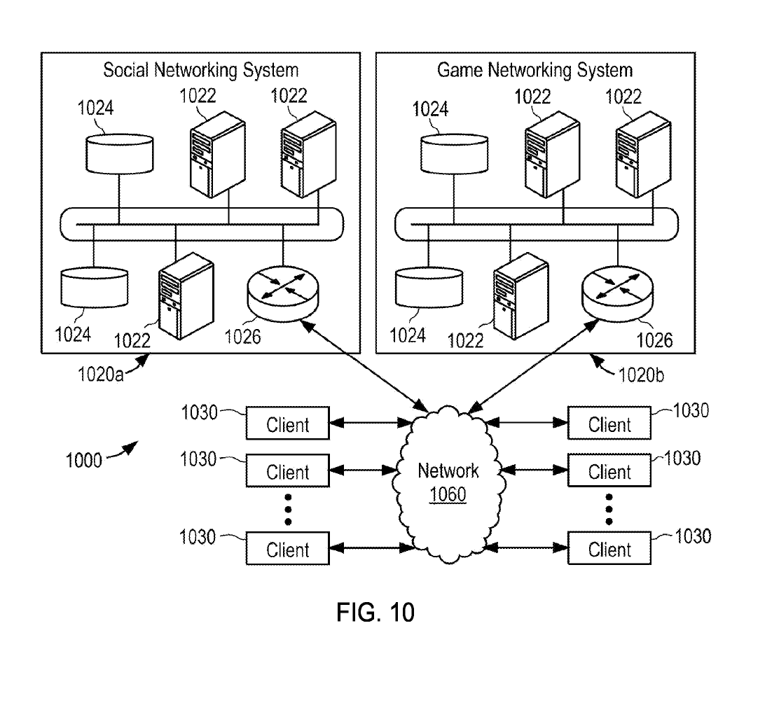

FIG. 10 illustrates an example network environment for the gaming system of FIG. 3, in accordance with an example embodiment. In one example embodiment, one or more described webpages may be associated with a networking system or networking service. However, alternate embodiments may have application to the retrieval and rendering of structured documents hosted by any type of network addressable resource or web site. Additionally, as used herein, a user may be an individual, a group, or an entity (such as a business or third party application).

Network cloud 1060 generally represents one or more interconnected networks, over which the systems and hosts described herein can communicate. Network cloud 1060 may include packet-based wide area networks (such as the Internet), private networks, wireless networks, satellite networks, cellular networks, paging networks, and the like. As FIG. 10 illustrates, particular embodiments may operate in a network environment comprising one or more networking systems, such as social networking system 1020a, game networking system 1020b, and one or more client systems 1030. The components of social networking system 1020a and game networking system 1020b operate analogously; as such, hereinafter may be referred to simply at networking system 1020. Client systems 1030 are operably connected to the network environment via a network service provider, a wireless carrier, or any other suitable means.

Networking system 1020 is a network addressable system that, in various example embodiments, comprises one or more physical servers 1022 and data stores 1024. The one or more physical servers 1022 are operably connected to network cloud 1060 via, by way of example, a set of routers and/or networking switches 1026. In an example embodiment, the functionality hosted by the one or more physical servers 122 may include web or HTTP servers, FTP servers, as well as, without limitation, webpages and applications implemented using Common Gateway Interface (CGI) script, PHP Hyper-text Preprocessor (PHP), Active Server Pages (ASP), HTML, XML, Java, JavaScript, Asynchronous JavaScript and XML (AJAX), Flash, ActionScript, and the like.

Physical servers 1022 may host functionality directed to the operations of networking system 1020. Hereinafter, servers 1022 may be referred to as server 1022, although server 1022 may include numerous servers hosting, for example, networking system 1020, as well as other content distribution servers, data stores, and databases. Data store 1024 may store content and data relating to, and enabling, operation of networking system 1020 as digital data objects. A data object, in particular embodiments, is an item of digital information typically stored or embodied in a data file, database, or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, and the like. Logically, data store 1024 corresponds to one or more of a variety of separate and integrated databases, such as relational databases and object-oriented databases, that maintain information as an integrated collection of logically related records or files stored on one or more physical systems. Structurally, data store 1024 may generally include one or more of a large class of data storage and management systems. In particular embodiments, data store 1024 may be implemented by any suitable physical system(s) including components such as one or more database servers, mass storage media, media library systems, storage area networks, data storage clouds, and the like. In one example embodiment, data store 1024 includes one or more servers, databases (e.g., MySQL), and/or data warehouses. Data store 1024 may include data associated with different networking system 1020 users and/or client systems 1030.

Client system 1030 is generally a computer or computing device including functionality for communicating (e.g., remotely) over a computer network. Client system 1030 may be a desktop computer, laptop computer, personal digital assistant (PDA), in- or out-of-car navigation system, smart phone or other cellular or mobile phone, or mobile gaming device, among other suitable computing devices. Client system 1030 may execute one or more client applications, such as a web browser (e.g., Microsoft Internet Explorer, Mozilla Firefox, Apple Safari, Google Chrome, and Opera), to access and view content over a computer network. In particular embodiments, the client applications allow a user of client system 1030 to enter addresses of specific network resources to be retrieved, such as resources hosted by networking system 1020. These addresses can be Uniform Resource Locators (URLs) and the like. In addition, once a page or other resource has been retrieved, the client applications may provide access to other pages or records when the user “clicks” on hyperlinks to other resources. By way of example, such hyperlinks may be located within the webpages and provide an automated way for the user to enter the URL of another page and to retrieve that page.

A webpage or resource embedded within a webpage, which may itself include multiple embedded resources, may include data records, such as plain textual information, or more complex digitally encoded multimedia content, such as software programs or other code objects, graphics, images, audio signals, videos, and so forth. One prevalent markup language for creating webpages is HTML. Other common web browser-supported languages and technologies include XML, the Extensible Hypertext Markup Language (XHTML), JavaScript, Flash, ActionScript, Cascading Style Sheet (CSS), and, frequently, Java. By way of example, HTML enables a page developer to create a structured document by denoting structural semantics for text and links, as well as images, web applications, and other objects that can be embedded within the page. Generally, a webpage may be delivered to a client as a static document; however, through the use of web elements embedded in the page, an interactive experience may be achieved with the page or a sequence of pages. During a user session at the client, the web browser interprets and displays the pages and associated resources received or retrieved from the website hosting the page, as well as, potentially, resources from other websites.

When a user at a client system 1030 desires to view a particular webpage (hereinafter also referred to as target structured document) hosted by networking system 1020, the user's web browser, or other document rendering engine or suitable client application, formulates and transmits a request to networking system 1020. The request generally includes a URL or other document identifier as well as metadata or other information. By way of example, the request may include information identifying the user, such as a user ID, as well as information identifying or characterizing the web browser or operating system running on the user's client system 1030. The request may also include location information identifying a geographic location of the user's client system 1030 or a logical network location of the user's client system 1030. The request may also include a timestamp identifying when the request was transmitted.

Although the example network environment described above and illustrated in FIG. 10 is described with respect to social networking system 1020a and game networking system 1020b, this disclosure encompasses any suitable network environment using any suitable systems. As an example and not by way of limitation, the network environment may include online media systems, online reviewing systems, online search engines, online advertising systems, or any combination of two or more such systems.

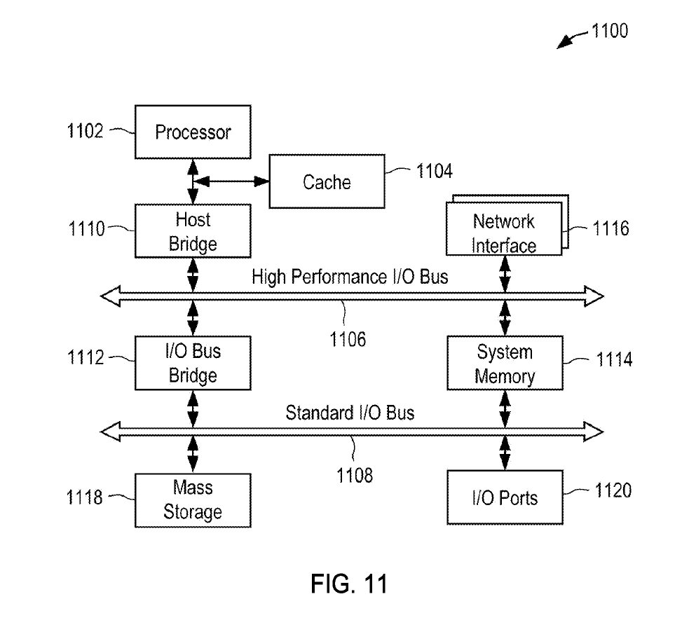

FIG. 11 illustrates an example of a computer system architecture 1100, in accordance with an example embodiment. The example computer system architecture 1100 may be used to implement a server 1022 or a client system 1030. In one embodiment, hardware system 1100 comprises a processor 1102, a cache memory 1104, and one or more executable modules and drivers, stored on a tangible computer readable medium, directed to the functions described herein. Additionally, hardware system 1100 may include a high performance input/output (I/O) bus 1106 and a standard I/O bus 1108. A host bridge 1110 may couple processor 1102 to high performance I/O bus 1106, whereas I/O bus bridge 1112 couples the two buses 1106 and 1108 to each other. A system memory 1114 and one or more network/communication interfaces 1116 may couple to bus 1106. Hardware system 1100 may further include video memory (not shown) and a display device coupled to the video memory. Mass storage 1118 and I/O ports 1120 may couple to bus 1108. Hardware system 1100 may optionally include a keyboard, a pointing device, and a display device (not shown) coupled to bus 1108. Collectively, these elements are intended to represent a broad category of computer hardware systems, including but not limited to general purpose computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

The elements of hardware system 1100 are described in greater detail below. In particular, network interface 1116 provides communication between hardware system 1100 and any of a wide range of networks, such as an Ethernet (e.g., IEEE 802.3) network, a backplane, and the like. Mass storage 1118 provides permanent storage for the data and programming instructions to perform the above-described functions implemented in servers 1022, whereas system memory 1014 (e.g., DRAM) provides temporary storage for the data and programming instructions when executed by processor 1102. I/O ports 1120 are one or more serial and/or parallel communication ports that provide communication between additional peripheral devices, which may be coupled to hardware system 1100.

Hardware system 1100 may include a variety of system architectures, and various components of hardware system 1100 may be rearranged. For example, cache 1104 may be on-chip with processor 1102. Alternatively, cache 1104 and processor 1102 may be packed together as a “processor module,” with processor 1102 being referred to as the “processor core.” Furthermore, certain embodiments of the present disclosure may not require nor include all of the above components. For example, the peripheral devices shown coupled to standard I/O bus 1108 may couple to high performance I/O bus 1106. In addition, in some embodiments, only a single bus may exist, with the components of hardware system 1100 being coupled to the single bus. Furthermore, hardware system 1100 may include additional components, such as additional processors, storage devices, or memories.

An operating system manages and controls the operation of hardware system 1100, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Of course, other embodiments are possible. For example, the functions described herein may be implemented in firmware or on an application-specific integrated circuit.

### Miscellaneous

Furthermore, the above-described elements and operations can be comprised of instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions are operational when executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

Certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain example embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in dedicated and permanently configured circuitry, or in temporarily configured circuitry (e.g., configured by software) may be driven by, for example, cost, time, energy-usage, and package size considerations.

Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

One or more features from any embodiment may be combined with one or more features of any other embodiment without departing from the scope of the disclosure.

A recitation of “a,” “an,” or “the” is intended to mean “one or more” unless specifically indicated to the contrary. In addition, it is to be understood that functional operations, such as “awarding,” “locating,” “permitting” and the like, are executed by game application logic that accesses, and/or causes changes to, various data attribute values maintained in a database or other memory.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

For example, the methods, game features and game mechanics described herein may be implemented using hardware components, software components, and/or any combination thereof. By way of example, while embodiments of the present disclosure have been described as operating in connection with a networking website, various embodiments of the present disclosure can be used in connection with any communications facility that supports web applications. Furthermore, in some embodiments the term “web service” and “website” may be used interchangeably and additionally may refer to a custom or generalized API on a device, such as a mobile device (e.g., cellular phone, smart phone, personal GPS, PDA, personal gaming device, etc.), that makes API calls directly to a server. Still further, while the embodiments described above operate with business-related virtual objects (such as stores and restaurants), the disclosure can be applied to any in-game asset around which a harvest mechanic is implemented, such as a virtual stove, a plot of land, and the like. The specification and drawings are, accordingly, to be regarded in an illustrative rather than a restrictive sense. It will, however, be evident that various modifications and changes may be made thereunto without departing from the broader spirit and scope of the disclosure as set forth in the claims and that the disclosure is intended to cover all modifications and equivalents within the scope of the following claims.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system for automated administration of a computer-implemented online social game, the system comprising:
a match-making loader configured to determine respective attributes of multiple players of the online social game for a plurality of player attribute types;
a match request module configured to receive a search request comprising one or more target attributes; and
a match-making system configured to identify one or more players of the online social game with attributes substantially matching the one or more target attributes and generate a recommendation of at least one matching player.

2. The dynamic match-making system of claim 1, wherein the match-making loader comprises:
a player index engine configured to build an index of player attributes of the online social game;
an index shard engine configured to shard the index into a plurality of shards; and
a dynamic key-store module configured to store the index shards.

3. The dynamic match-making system of claim 1, wherein the one or more player attributes are generated via one or more game models.

4. The dynamic match-making system of claim 1, wherein the match-making system is further configured to access one or more of the index shards to identify the one or more players of the online social game.

5. A method for automated administration of a computer-implemented online social game, the method comprising:
determining respective attributes of multiple players of the online social game for a plurality of player attribute types;
receiving a search request comprising one or more target attributes;
identifying one or more players of the online social game with attributes substantially matching the one or more target attributes; and
generating a recommendation of at least one matching player.

6. The method of claim 5, further comprising:
building an index of player attributes of the online social game;
dividing the index into a plurality of shards; and
storing the index shards.

7. The method of claim 5, wherein the one or more player attributes are generated via one or more game models.

8. The method of claim 5, further comprising accessing one or more of the index shards to identify the one or more players of the online social game.

9. A non-transitory machine-readable storage medium embodying a set of instructions that, when executed by at least one processor, causes the processor to perform operations, the operations comprising:
determining respective attributes of multiple players of the online social game for a plurality of player attribute types;
receiving a search request comprising one or more target attributes;
identifying one or more players of the online social game with attributes substantially matching the one or more target attributes; and
generating a recommendation of at least one matching player.

10. The non-transitory machine-readable storage medium of claim 9, further comprising instructions that, when executed by at least one processor, causes the processor to perform further operations, the further operations comprising:
building an index of player attributes of the online social game;
dividing the index into a plurality of shards; and
storing the index shards.

11. The non-transitory machine-readable storage medium of claim 9, wherein the one or more player attributes are generated via one or more game models.

12. The non-transitory machine-readable storage medium of claim 9, further comprising instructions that, when executed by at least one processor, causes the processor to access one or more of the index shards to identify the one or more players of the online social game.
